(19) United States
(12) Patent Application Publication
(10) Pub. No.: US 2015/0332332 A1
(43) Pub. Date: Nov. 19, 2015

(54) SELF-DESTRUCTING AD MESSAGES IN MESSAGING APPS

(71) Applicant: Ahmed Saif Al Darmaki, Abu Dhabi (AE)

(72) Inventor: Ahmed Saif Al Darmaki, Abu Dhabi (AE)

(21) Appl. No.: 14/278,427

(22) Filed: May 15, 2014

(51) Int. Cl. G06Q 30/02; G06F 3/0484

(52) U.S. Cl. CPC G06Q 30/0267; G06Q 30/0272; G06F 3/04842

(57) ABSTRACT

The present application is directed to systems and methods for providing and displaying advertising messages within applications running on smart phones, tablets and other mobile devices while minimizing the disruptive effect of those advertising messages. The application may include an instant messaging or chat function. Within the application, advertising content may be presented in the portion of the screen dedicated to displaying the instant messaging or chat conversation, or in the portion of the screen dedicated to displaying a list of conversations, contacts or other content. The advertising content is set to be displayed for a certain amount of time and the display may indicate the amount of time remaining before the advertising content will disappear. The advertising content may include, for example, a limited-time offer that the user may accept while the advertising content is displayed.

### TECHNICAL FIELD

The present application is directed to systems and methods for providing and displaying advertising content within messaging and chat applications running on smart phones, tablets, and other mobile devices while minimizing the disruptive effect of the advertising content.

### BACKGROUND OF THE INVENTION

Presenting advertising content within applications on mobile devices has become a popular way to derive income from use of mobile devices. The term application in this disclosure includes “apps,” as applications that run on mobile devices have come to be known. Application developers and service and content providers often offer mobile device applications for free or at a nominal cost. Developers or providers then derive income from use of these applications by displaying advertisements to their users while the applications are running. These advertisements are usually banners that appear in a static location on the screen. FIGS. 1A and 1B illustrate this type of advertisement in the prior art.

However, this type of advertisement on mobile devices is troublesome to many developers and users because it occupies valuable screen space that is no longer available for the application user interface. This problem is exacerbated by the fact that mobile devices have relatively small screens that constrain the space available for the user interface and the application's own content.

### SUMMARY

The present application is directed to systems and methods for providing and displaying ephemeral advertising messages within instant messaging and chat applications running on smart phones, tablets and other mobile devices while minimizing the disruptive effect of those advertising messages. The application may include an instant messaging or chat function whereby the user communicates with other users. Within the application, advertising content may be presented in the portion of the screen dedicated to displaying the instant messaging or chat conversation. The advertising content is set to be displayed for a certain amount of time. The display may indicate the amount of time remaining before the advertising content will disappear. The advertising content may include, for example, a limited-time offer that the user may accept while the advertising content is displayed, but expires when the advertising content disappears.

The application may also include a list of instant messaging or chat conversations, friends, contacts, buddies, groups, feeds, news, communities, photos, videos, music, favorites or other content. Within the application, advertising content may be presented in the portion of the screen dedicated to displaying this list of conversations, contacts or other content. When presented in this portion of the screen, the advertising content may be set to be displayed for a certain amount of time. In some aspects, the display indicates the amount of time remaining before the advertising content will disappear. The advertising content may include a limited-time offer that the user may accept while the advertising content is displayed, but expires when the advertising content disappears.

### BRIEF DESCRIPTION OF THE DRAWINGS

FIG. 1A illustrates an example of a prior art banner advertisement within an application on a mobile device.

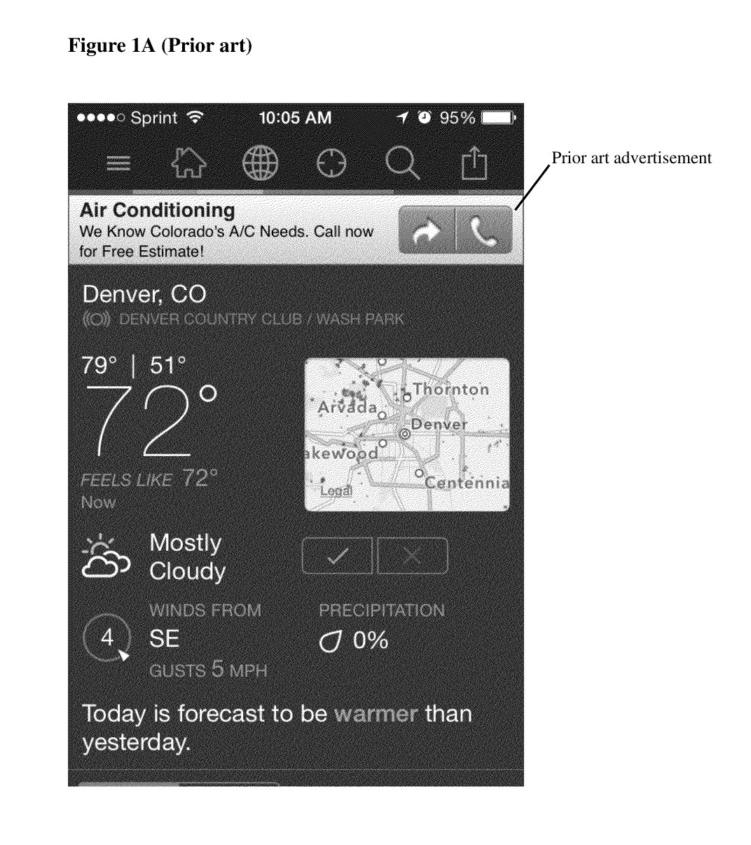

FIG. 1B illustrates another example of a prior art banner advertisement within an application on a mobile device.

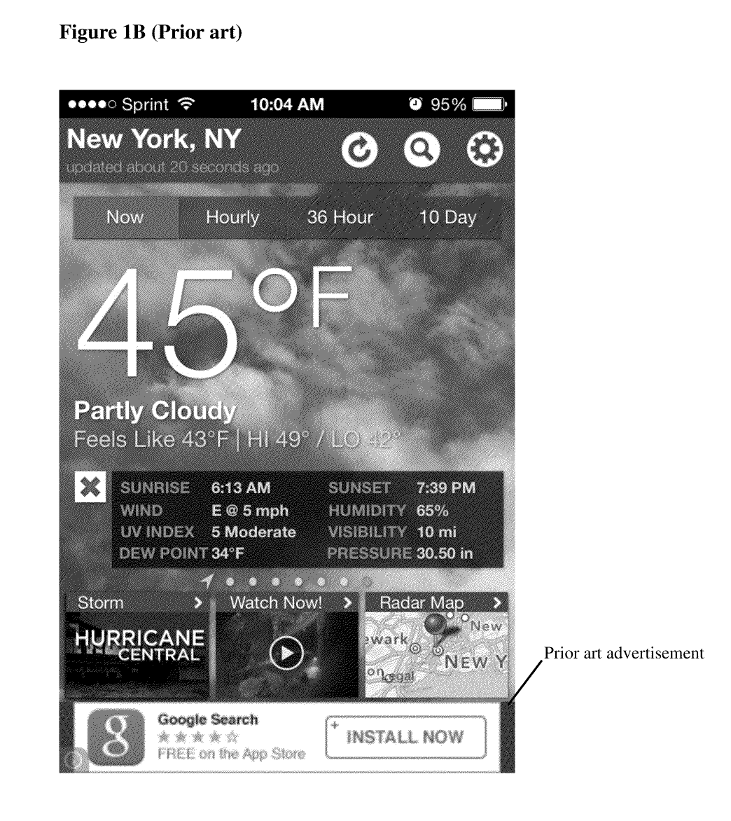

FIG. 2A is a block diagram of one aspect of the invention, depicting the creation, communication and consumption of content.

FIG. 2B is a block diagram of another aspect of the invention, depicting the creation, communication and consumption of content.

FIG. 3A is an illustration of advertising content displayed within the portion of an application user interface dedicated to displaying an instant messaging or chat conversation, according to the instant invention.

FIG. 3B is an illustration of advertising content displayed within the portion of an application user interface dedicated to displaying an instant messaging or chat conversation that highlights the time remaining field, according to the instant invention.

FIG. 4 is an illustration of advertising content displayed within the portion of an application user interface dedicated to displaying a list of instant messaging or chat conversations, friends, contacts, buddies, groups, feeds, news, communities, photos, videos, music, favorites or other content, according to the instant invention.

FIG. 5 is an exemplary block diagram of one type of mobile device that may be used with the instant invention.

### DETAILED DESCRIPTION

Methods and systems for presenting advertising content within instant messaging or chat applications on mobile devices are disclosed. The methods and systems described herein can also be used in other types of communication applications, such as email applications. In addition, these methods and systems can be applied in the context of non-mobile devices, including any non-mobile device used to access the internet or any non-mobile device that provides messaging or advertising capabilities. For example, the methods and systems described herein can be applied to in-store kiosks or other fixed hardware that displays advertising or allows a user to communicate with other users or with a central office of the store.

The methods and systems include a mobile device running an application that includes instant messaging, chat or social media functions. The user interface of this application may include a display area, referred to herein as a message display, that shows an instant messaging, chat, or email conversation. A message display typically includes user interface elements that correspond to individual messages within a conversation—such as, for example, speech balloons or speech bubbles. Alternatively, a message display may depict one-way communications such as, for example, news feeds, blog feeds or other one-to-many messages. The user interface may also include a display area, referred to herein as a list display, that shows lists of instant messaging or chat conversations, friends, contacts, buddies, groups, feeds, news, communities, photos, videos, music, favorites or other content. A list display includes user interface elements that correspond to items in the list, such as individual instant messaging or chat conversations. Making a selection from an item in the list display may direct the user interface to a corresponding message display.

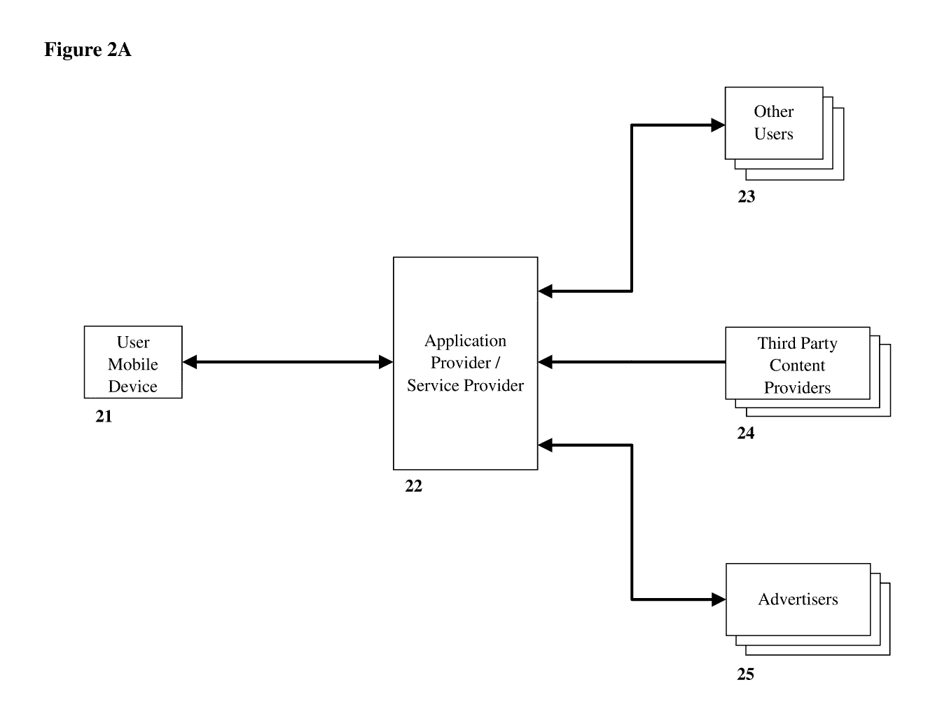

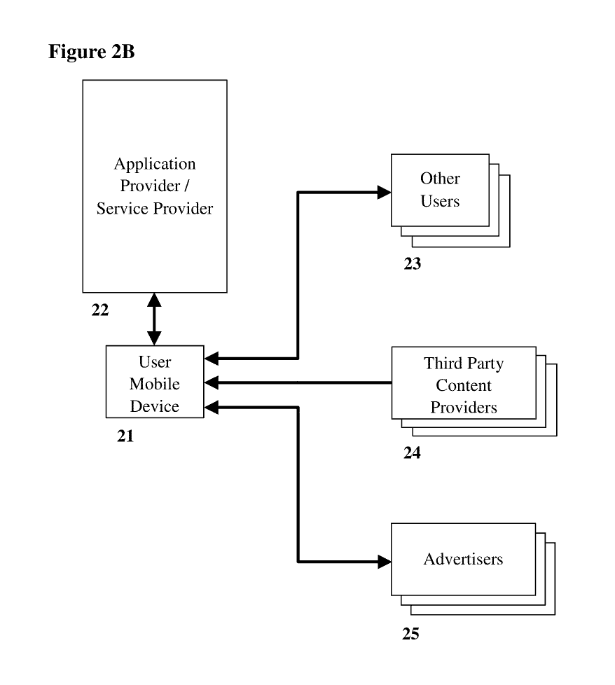

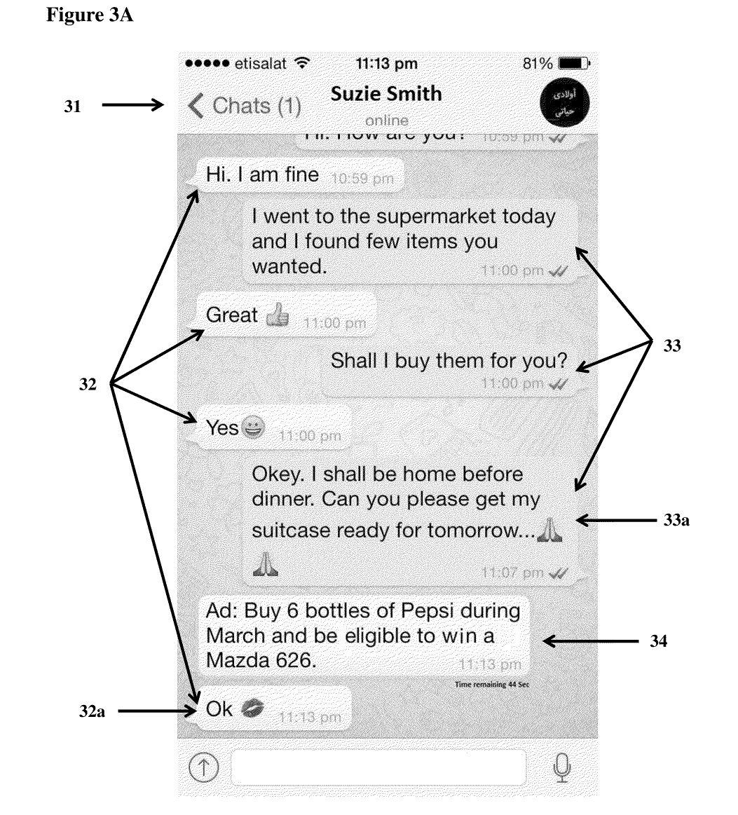

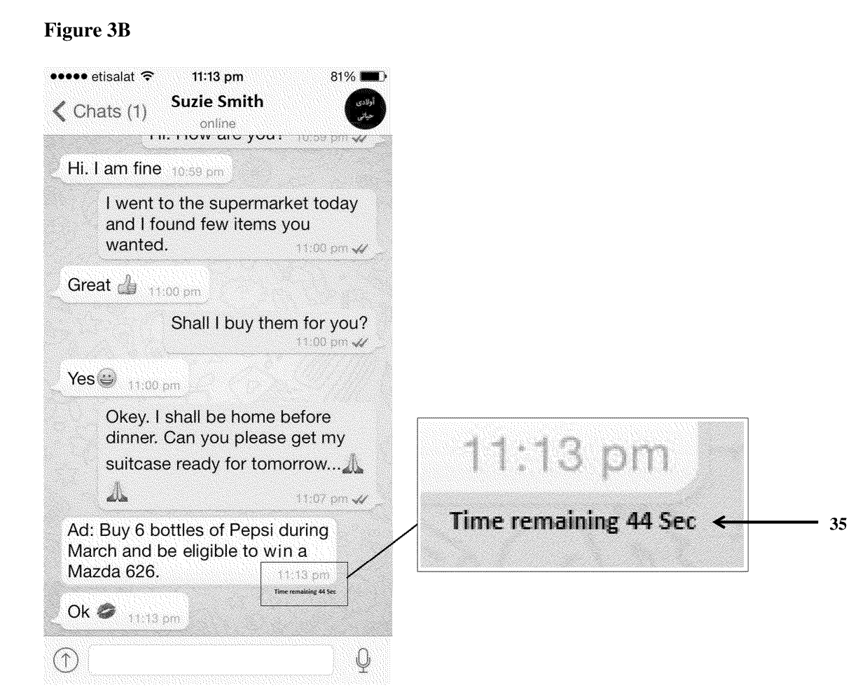

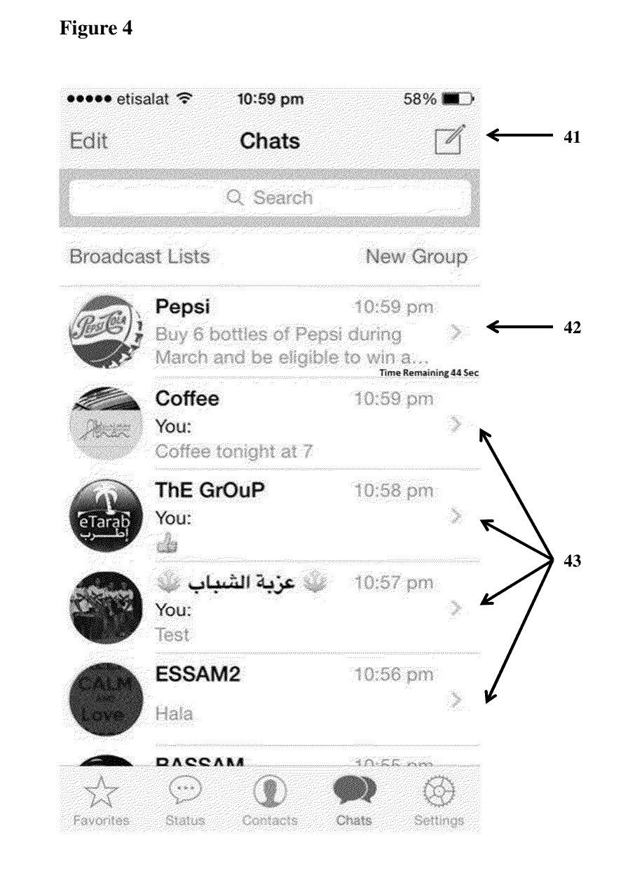

As shown in FIG. 2A, a mobile device 21 may receive many different types of messages from various sources via the application provider or service provider 22. A mobile device 21 may receive messages from other users 23 and respond with messages of its own. A mobile device 21 may also receive content from third party content providers 24, such as news sources, blogs or other sources of broadcast one-to-many content providers. An application running on mobile device 21 may display conversations comprising one or more messages exchanged with other users 23, as well as content received from third party content providers 24 in one or more message displays. The application running on mobile device 21 may also display, as a separate part of the user interface, a list of these conversations or sources of content in a list display. In addition to other users 23 and third party content providers 24, the mobile device may also receive messages or content from one or more advertisers 25. Messages and content from advertisers 25 are displayed in the message display or the list display in a manner that resembles messages and content from other users 23 and third party content providers 24, as described below and illustrated in FIGS. 3A, 3B and 4. According to one aspect of the present invention, the application provider or service provider may present an interface through which it will receive advertising content and either forward or serve that advertising content to the users. Alternatively, the application provider or service provider may act as a central clearinghouse for advertising content and retain some editorial control over the content.

Advertisers 25 may create and submit advertising content through the application provider or service provider 22 without any particularized knowledge of the characteristics, attributes, actions or patterns of actions of mobile device 21. In this case, advertising content can be predetermined and adjusted periodically on a timeframe determined unilaterally by advertisers 25 or the application provider or service provider 22, or by some arrangement between them. The mobile device 21 may report data related to characteristics, attributes, actions or patterns of actions of mobile device 21 or its user to the application provider or service provider 22, which could, in turn, forward this information to advertisers 25. In these instances, advertising content can be selected or adapted based on this data. For example, if a characteristic of mobile device 21 is a cellular phone network for which it is enabled, the advertiser 25 or the application provider or service provider 22 may choose not to present any advertising content related to the cellular phone network to which mobile device 21 is already subscribed. Alternatively, if mobile device 21 reports data related to patterns of action taken on the mobile device, the advertiser 25 or the application provider or service provider 22 could advantageously select or compose advertising content calculated to be of interest to the particular user of mobile device 21. Mobile device 21 could report data related to a conversation the user is currently having, attributes inferred from past or present conversations, demographic information about the user, or times that the user runs the application or other applications.

FIG. 2B depicts an alternative design and configuration where communications between the various entities 23, 24 and 25 are not routed through or via the application provider or service provider 22, but may be directly sent to or exchanged with the mobile device 21. In this configuration, the application provider or service provider may design an interface through which advertisers can push advertisements directly to users. The mobile device 21 may report data related to characteristics, attributes, actions or patterns of actions of the mobile device 21 or its user directly to advertisers 25. As noted above, advertisers 25 could select or adapt advertising content based on this data. One of skill in the art will recognize that this invention will work in either of these configurations, or any combination of central or distributed communication routing.

FIG. 3A depicts an example of a message display 31 from a messaging application. This message display 31 shows a conversation comprising messages exchanged between Suzie Smith and her partner, in which the user interface elements corresponding to each message, referred to herein as message elements, are speech bubbles and the user interface element corresponding to the advertising content, referred to herein as an advertisement element, is a rounded rectangle. Suzie Smith's messages to her partner 32 are depicted in speech bubbles originating from the left hand side of the message display 31 and her partner's messages to her 33 are depicted in speech bubbles originating from the right hand side of the message display 31. Advertisement element 34 is displayed during the conversation after the message received at 11:07 p.m. 33a but before the message sent at 11:13 p.m. 32a. Advertisement element 34 stays embedded within the conversation and scrolls up the screen as the conversation progresses. Alternatively, advertisement element 34 may not be embedded within the current conversation, but rather be displayed before the first or after the last visible message element within the message display. In this configuration, advertisement element 34 does not scroll up or down as newer messages are received. Advertisement element 34 resembles message elements 32 and 33, but is distinguishable from those message elements, such as by appearing within a rounded rectangle outlined in a different color as compared to the speech bubbles used for message elements 32 and 33 as shown in FIG. 3A. Advertisement element 34 may be differentiated from message elements 32 and 33 in additional or alternative ways, such as for example by using a different size or shape, different font, font style, or font size, a different text color, or a different background color. Alternatively, advertisement element 34 could appear in the same format and style as the messages in the conversation. One skilled in the art will recognize that there are many ways to implement a message display and that this invention is not limited to any particular implementation.

FIG. 3B depicts the same message display as FIG. 3A, but highlighting the time remaining field 35 of advertisement element 34. A variable but predetermined display duration is associated with the advertising content displayed in advertisement element 34. When the display duration expires, advertisement element 34 disappears from the message display and is no longer retrievable or viewable by the user. While advertisement element 34 is displayed, the remaining display duration is shown in the user interface in a time remaining field 35, which is continuously updated as the display duration elapses. The display duration may be determined by the advertiser, by the application/service provider, by agreement between the advertiser and the application/service provider, or by some other method. The display duration may be infinite, in which case advertisement element 34 will not automatically disappear, but rather persist within the conversation as a normal message until deleted in some other fashion by the user or application.

The display duration may be measured from the time the advertising content is received by the mobile device, or from some later instant, such as when the advertising content is visibly displayed, after a certain number of messages have been sent or exchanged, or after the user has taken some other subsequent action. If the mobile device is configured to report data related to the current conversation, the application/service provider or advertisers could determine the identities of the parties to a conversation and present the same or related advertising content to each of those users.

FIG. 4 depicts an example of a list display 41 from a messaging application. This list display 41 includes user interface elements 43 corresponding to a list of conversations in which a message has recently been sent or received, referred to herein as conversation elements. In this list display, conversation elements 43 are sorted such that the conversation with the most recent activity appears at the top of the list display 41. An advertisement element 42 appears at the top of the list display. The advertisement element 42 may be sorted in the list display like any other item, such that advertisement element 42 will be replaced at the top of the list display 41 when activity occurs in a different conversation. Alternatively, advertisement element 42 is not sorted with the other items in the list display, but rather remains at a static location in the list display 41 for its entire display duration regardless of subsequent activity in other conversations. Advertisement element 42 resembles conversation elements 43, but is distinguishable because an icon representing the advertiser's logo is displayed within advertisement element 42. Advertisement element 42 may be differentiated from conversation elements 43 in additional or alternative ways, such as for example by using a different size or shape, different font, font style, or font size, a different text color, or a different background color. Advertisement element 42 may display a time remaining field, and disappear from the list display when its display duration expires, as discussed above. One skilled in the art will recognize that there are many ways to implement a list display and that this invention is not limited to any particular implementation. In other embodiments, the list display may include friends, contacts, buddies, groups, feeds, news, communities, photos, videos, music, favorites or other content. Alternatively, the advertising content is not differentiated from the other content that appears within list display. Rather, an advertising message within the list display is identical in appearance to the other listed items.

Regardless of whether advertising content appears in a message display or a list display, the content may include a link that the user may activate, such as a uniform resource locator (“URL”) or some other reference to a resource on the mobile device or an information resource external to the mobile device. When the user activates such a link, further information associated with the advertisement is provided. For example, activation of a link may trigger a popup window or dialog box, open a new page within the application, open a web browser to display a web page or invoke a different application on the mobile device. The advertising content may include an offer that the user can accept by activating a link within the advertising content, with the offer remaining valid for the display duration of the advertisement and expiring when the advertisement disappears.

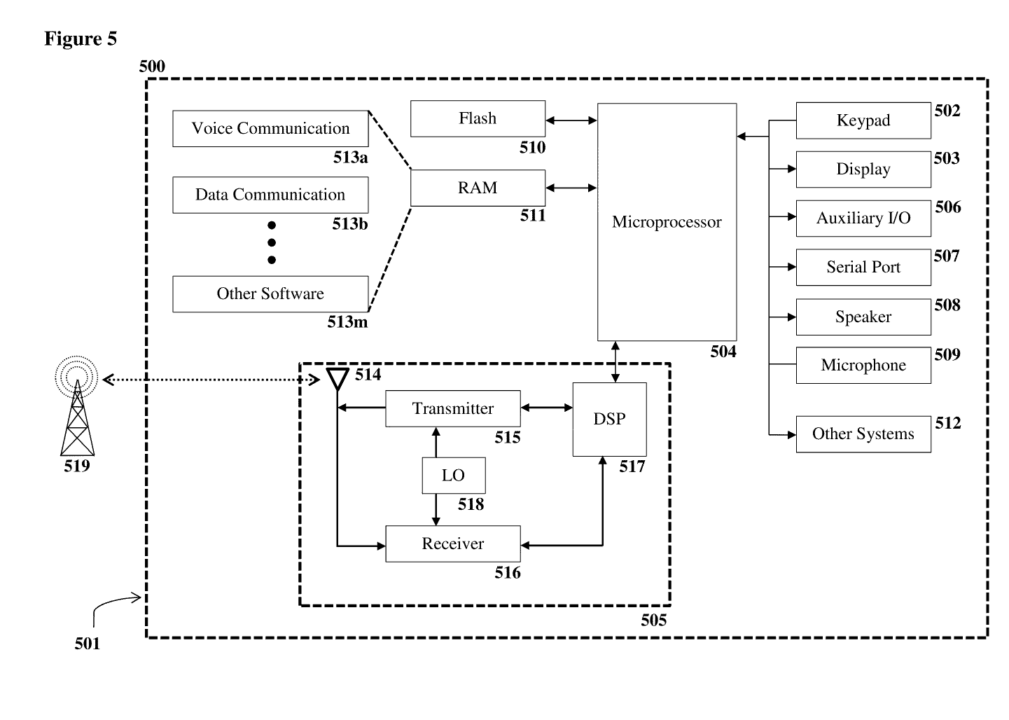

Exemplary components of a mobile device 500 that may be used in accordance with the invention are described below with reference to FIG. 5. The device 500 may include a housing 501, a keypad 502 and a visual display device 503. The visual display device 503 may comprise a full graphic liquid crystal display (“LCD”). In some embodiments, display 503 may comprise a touch-sensitive input and output device. Alternatively, other types of output device may be used. The housing 501 contains a processing device 504, which is coupled to the keypad 502 (or touch-sensitive input) and the display 503. The processing device 504 controls the overall operation of the mobile device 500. In some embodiments, keypad 502 may comprise a virtual keypad (e.g., using a touch-sensitive interface) or a physical keypad or both.

Other parts of the mobile device 500 are also shown schematically in FIG. 5. These include a communications system 505; other input/output devices 506, 507, 508 and 509; memory devices 510 and 511; and various other systems 512. The mobile device 500 may comprise two-way radio frequency (“RF”) communications components that are capable of communicating both voice and data. The mobile device 500 may also communicate with other computer systems via the Internet or other networks.

Persistent store, such as Flash memory 510 or read-only memory (“ROM”), may contain operating system software to be executed by the processing device 504. System software and specific device applications may be loaded temporarily into a volatile store, such as random access memory (“RAM”) 511. The mobile device may also store communications signals that it receives in the RAM 511.

The processing device 504, in conjunction with its operating system functions, executes software applications 513a to 513m on the device 500. Applications that conduct and control basic device operations, such as data and voice communications 513a and 513b, may be installed on the device 500 during the manufacturing process.

The communications system 505 handles communication functions, including data and voice communications. The communications system 505 includes one or more antennas 514, a transmitter 515 and a receiver 516. In addition, the communications system 505 may include a second processing device, such as a digital signal processor (“DSP”) 517, and one or more local oscillators (“LO”) 518. The precise implementation of the communications system 505 depends upon the communications network in which the mobile device 500 is designed to operate.

After a network registration or activation process has been completed, the mobile device 500 may send and receive communications signals over the communication network 519. Signals received from the communications network 519 by the antenna 514 are routed to the receiver, which amplifies the signal, down-converts the frequency, filters and selects a channel, and convert the analog signal to a digital signal. Analog-to-digital conversion of the received signal allows the DSP 517 to perform more complex communications functions, such as demodulation and decoding. In a similar manner, signals to be transmitted to the network 519 are processed by the DSP 517 and are then provided to the transmitter 515 for digital to analog conversion, frequency up conversion, filtering, amplification and transmission to the communication network 519 (or networks) via the antenna 514.

1. A method of presenting advertising content within an application running on a device, the method comprising:
providing an application adapted to run on a device, wherein the user interface of the application includes at least one of a message display and a list display;
communicating advertising content to the application running on the device, wherein a display duration is associated with the advertising content;
displaying the advertising content within an advertisement element in at least one of the message display and the list display; and
removing the advertising content from the user interface when the display duration has elapsed.

2. The method of claim 1 wherein the advertisement element includes a timer that indicates the amount of time remaining from the display duration before the advertising content is removed from the user interface.

3. The method of claim 1 wherein the display duration associated with the advertising content is infinite.

4. The method of claim 1 wherein the advertisement element resembles the other user interface elements of the message display.

5. The method of claim 1 wherein the advertisement element resembles the other user interface elements of the list display.

6. The method of claim 1 wherein the advertisement element includes a link that can be activated by a user.

7. The method of claim 6 wherein the advertising content includes an offer that can be accepted by the user; and the user accepts the offer by activating the link.

8. A system adapted to present advertising content, the system comprising:
a device capable of acting upon machine-executable instructions;
an application provider subsystem, wherein the application provider subsystem provides to the device an application that (a) has a user interface including at least one of a message display and a list display and (b) is adapted to display advertising content within an advertisement element in at least one of the message display and the list display; and
an advertisement subsystem, wherein the advertisement subsystem communicates to the application running on user device advertising content that is associated with a display duration.

9. The system of claim 8 wherein the application is further adapted to present a timer that indicates the amount of time remaining from the display duration before the advertising content is removed from the user interface.

10. The system of claim 8 wherein the display duration associated with the advertising content is infinite.

11. The system of claim 8 wherein the advertisement element resembles the other user interface elements of the message display.

12. The system of claim 8 wherein the advertisement element resembles the other user interface elements of the list display.

13. The system of claim 8 wherein the advertisement element includes a link that can be activated by a user.

14. The system of claim 13 wherein the advertising content includes an offer that can be accepted by the user; and the user accepts the offer by activating the link.
